(19) United States
(12) Patent Application Publication
(10) Pub. No.: US 2024/0422100 A1
(43) Pub. Date: Dec. 19, 2024

(54) VIRTUAL CXL SWITCH

(71) Applicant: XConn Technologies Holdings, Inc., San Jose, CA (US)

(72) Inventors: Christopher Helps, El Cerrito, CA (US); Yan Fan, Los Altos Hills, CA (US)

(21) Appl. No.: 18/742,958

(22) Filed: Jun. 13, 2024

Related U.S. Application Data
(60) Provisional application No. 63/521,612, filed on Jun. 16, 2023.

(51) Int. Cl. H04L 45/76; H04L 45/74; H04L 49/00

(52) U.S. Cl. CPC H04L 45/76; H04L 45/74; H04L 49/70

(57) ABSTRACT

A switch including physical ports, virtual switches, and a switch fabric is described. A virtual switch of the virtual switches includes virtual ports corresponding to the physical ports of the switch and is configured to provide a translated routing structure (TRS). The TRS corresponds to a local identifier of a source device coupled with a corresponding physical port and is unique to the source device for the switch. The switch fabric interconnects the physical ports. In some embodiments, the switch is a compute express link (CXL) switch.

### CROSS REFERENCE TO OTHER APPLICATIONS

This application claims priority to U.S. Provisional Patent Application No. 63/521,612 entitled VIRTUAL CXL SWITCH filed Jun. 16, 2023 which is incorporated herein by reference for all purposes.

### BACKGROUND OF THE INVENTION

In order to accommodate the volume and speed at which data are produced by, stored, and exchanged between hosts (e.g. processors) in a system, interconnects (e.g. switches) are desired to have a high data exchange rate. For example, hosts and physical memory devices are coupled to ports of the switch. Each host is typically assigned to a dedicated physical memory device. Through the switch, a host on one port of the switch connects to its dedicated physical memory device on another port of the switch. Although this allows for hosts to use physical memory devices, the desired data exchange rates and latencies may not be achieved. This failure may result in critical bottlenecks to system performance. Moreover, other configurations of switches, hosts and physical memory devices may not be supported. Consequently, improved mechanisms for storing and transferring data between components are desired.

### BRIEF DESCRIPTION OF THE DRAWINGS

Various embodiments of the invention are disclosed in the following detailed description and the accompanying drawings.

FIG. 1 is a block diagram illustrating an embodiment of a switch.

FIG. 2A is a block diagram illustrating an embodiment of a switch.

FIG. 2B is a diagram illustrating an embodiment of a packet and a corresponding TRS.

FIG. 3 is a block diagram illustrating an embodiment of switches.

FIGS. 4A and 4B are flow diagrams illustrating embodiments of processes for communicating via a switch.

FIG. 5 is a flow diagram illustrating an embodiment of process for configuring a virtual switch.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

In some networks, hosts (e.g. processors such as CXL hosts) are connected to physical devices (e.g. physical memory devices such as CXL memory devices) via interconnects (e.g. switches). Each host and each physical device is connected to the switch via a port. Each host on one port is typically assigned to a dedicated physical memory device on another port. Although this allows for hosts to use physical memory devices, other configurations of switches, hosts, and physical memory devices may not be supported. Therefore, improved mechanisms for storing and transferring data between hosts and devices are desired.

A switch including physical ports, virtual switches, and a switch fabric is described. A virtual switch includes virtual ports corresponding to the physical ports of the switch and is configured to provide a translated routing structure (TRS). The TRS corresponds to a local identifier (i.e. may be used to access a local identifier) of a source device coupled with a corresponding physical port. The TRS is unique to the source device for the switch (e.g. may include an identifier for the physical port of the source device). The switch fabric interconnects the physical ports. In some embodiments, the switch is a compute express link (CXL) switch.

In some embodiments (e.g., multi-host configurations), a management host is coupled to the switch. The management host intercepts initial configuration communications from the other hosts and configures the virtual switch based on the initial communications. In some embodiments, configuring the virtual switch includes mapping the local identifier of the source device to a location in the virtual switch indicated by the virtual port. The management host may determine a global address space for devices connected to the switch. In some embodiments, the virtual switch omits the TRS for a transaction between the source device and the management host.

In some embodiments, the virtual switch provides a translation of a local address for a destination to a global address for the destination. For example, virtual switch(es) may connect multiple virtual ports for hosts to the same physical device. Each host may connect to the physical device via a different virtual port. In this example, the virtual port may provide the translation between the local address for a virtual port destination and the global address for the physical destination. In some embodiments, therefore, this address translation may associate each virtual port with a different portion of the downstream device memory; or all virtual ports connected to that device may be associated with the same portion of device memory. In some embodiments, a physical port is connected to a device comprising multiple logical devices. In some such embodiments, the virtual port includes an identifier of a logical device of the multiple logical devices. This identifier of the logical device may be included in the TRS. Thus, each of the multiple logical devices may be associated with a corresponding unique global address.

In some embodiments, the switch routes a response from the destination based at least in part on the source identifier in the TRS. For example, the switch may replace a portion of a request packet with a TRS, which may contain a global source identifier. The response may share a format of the packet sent by the source device. In this case, when the response packet returns the virtual port for the source, the TRS is replaced by that portion of the original request packet. Thus, the TRS may also contain information used to retrieve the original packet portion.

In some embodiments, the source device is a second switch. The second switch may determine a global address space for devices connected to the second switch including devices connected to the (first) switch. A global address space for the first switch may correspond to a portion of the global address space for devices connected to the second switch. Thus, communication across multiple switches may be supported.

In some embodiments, the TRS includes an indicator of whether or not the TRS is in use in a transaction. Thus, the virtual switch may be configured to perform a first set of actions in response to receiving a transaction including a TRS and a second set of actions in response to receiving a transaction not including a TRS. In some embodiments, a portion of a packet is overwritten by the TRS. For example, the local identifier of the source device may appear in the packet and be overwritten by the TRS. In some embodiments, the portion of the packet overwritten by the TRS is stored on the switch. In some such embodiments, the TRS includes an address of the portion of the packet overwritten by the TRS stored on the switch. The virtual switch may receive a response to the packet, the response including the TRS. In some embodiments, the virtual switch is configured to replace the TRS in the response with the portion of the packet stored on the switch. Thus, the response may share the format of the packet sent by the source device.

In some embodiments, the physical ports include a first downstream port and a second downstream port. The first downstream port is connected to a first device and the second downstream port is connected to a second device. The first device is able to exchange peer-to-peer communications with the second device via the switch fabric. The first device and the second device may be used by two distinct hosts.

A method is described. The method may be used for storing data, reading data, transferring data and/or other operations in connection with physical devices. The method includes receiving, at a virtual switch, a communication from a source device to a destination device. The source device is coupled to a physical port corresponding to the virtual switch. The physical port is one of multiple physical ports. The method also includes providing, for the communication, a TRS corresponding to the local identifier of the source device. The TRS is unique to the source device and is usable in routing a response from the destination device to the source device.

A method that may be used for storing data, reading data, transferring data and/or other operations in connection with physical devices is described. The method includes intercepting, by a management host coupled with a switch, initial communications of a host device. The host device is coupled with a physical port of the physical ports of the switch. The method also includes configuring a virtual switch corresponding to the physical port based on the initial communications. The configuring includes determining a global identifier for the host device and configuring the virtual switch to provide a TRS corresponding to a local identifier of the host device. The TRS is unique to the host device for the switch and is based on the global identifier.

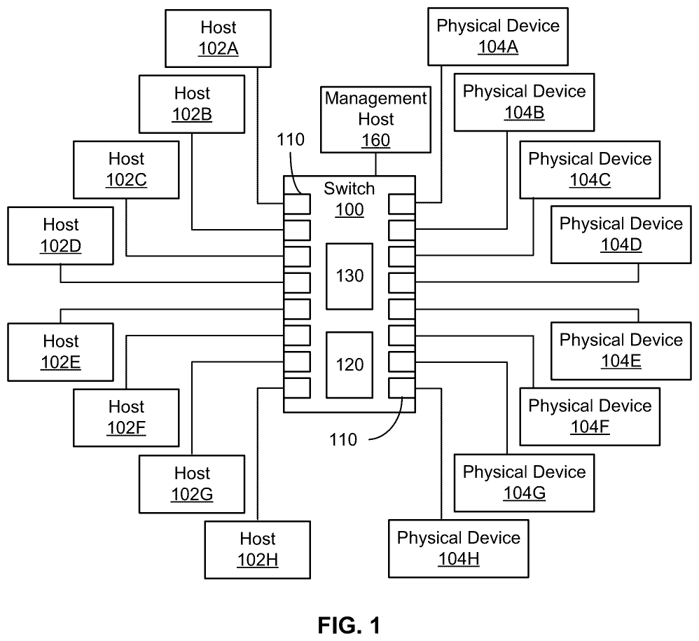

FIG. 1 is a block diagram illustrating an embodiment of switch 100. Switch 100 includes ports 110 (only two of which are labeled), fabric management module 120, and switch fabric 130. Switch 100 is coupled with management host 160. Hosts 102A, 102B, 102C, 102D, 102E, 102F, 102G, and 102H (collectively or generically, host(s) 102) are shown coupled to ports 110. Similarly, physical devices 104A, 104B, 104C, 104D, 104E, 104F, 104G, and 104H (collectively or generically physical devices 104) are shown coupled to other ports 110. Physical devices 104 may be physical memory devices, such as CXL memory devices. Hosts 102 may include processors and may be CXL hosts. In some embodiments, hosts 102 and/or physical devices 104 may include other devices. For example, in some embodiments, a switch (not shown in FIG. 1) may be coupled with a port 110 in an analogous manner to a host 102.

Switch 100 allows for communication between hosts 102 and physical devices 104. Using switch 100, each host 102 may utilize multiple physical devices 104. For example, host 102A may store data to and read data from physical devices 104C and 104D. Further, multiple hosts 102 may share a single physical device 104. For example, hosts 102A and 102C may both store data to and read data from physical device 104G. In some such embodiments, hosts 102 may store data to and read data from distinct portions of the single physical device 104. The single physical device 104 may also include multiple logical devices. Further, switch 100 allows for peer-to-peer communication between physical devices 104. For example, physical device 104G may store data to and retrieve data from physical device 104A.

Management host 160 intercepts initial communications of hosts 102. The initial communications from hosts 102 may be used to enumerate the devices and/or ports to which a host 102 is connected as well as to provide the local identifier for the host. Because each host provides its identity, without more, there may be conflicts between the (local) host identifier. In some embodiments, management host 160 intercepts the initial communications via fabric management module 120. One or more virtual switches (not shown in FIG. 1) are configured based on the initial communications. For example, a virtual switch corresponding to a port 110 coupled with host 102A may be configured to provide a TRS unique to switch 100 corresponding to a local identifier of host 102A. The TRS thus incorporates the local identifier for the host and may be considered to be or include the global address for the host used in routing responses to host 102. In some embodiments, configuring the virtual switch includes mapping the local identifier of host 102A to a location in the virtual switch indicated by the TRS. The virtual switch may then provide the TRS for a communication from host 102A. In some embodiments, the virtual switch provides a translation of a local address for a destination to a global address for the destination. For example, for a communication from host 102A to physical device 104C, the virtual switch translates an address local to host 102A to a global address for physical device 104C. Thus, management host 160 may determine a global address space for switch 100. Switch 100 may also route a response to the communication (e.g., from physical device 104C back to host 102A) based at least in part on the TRS.

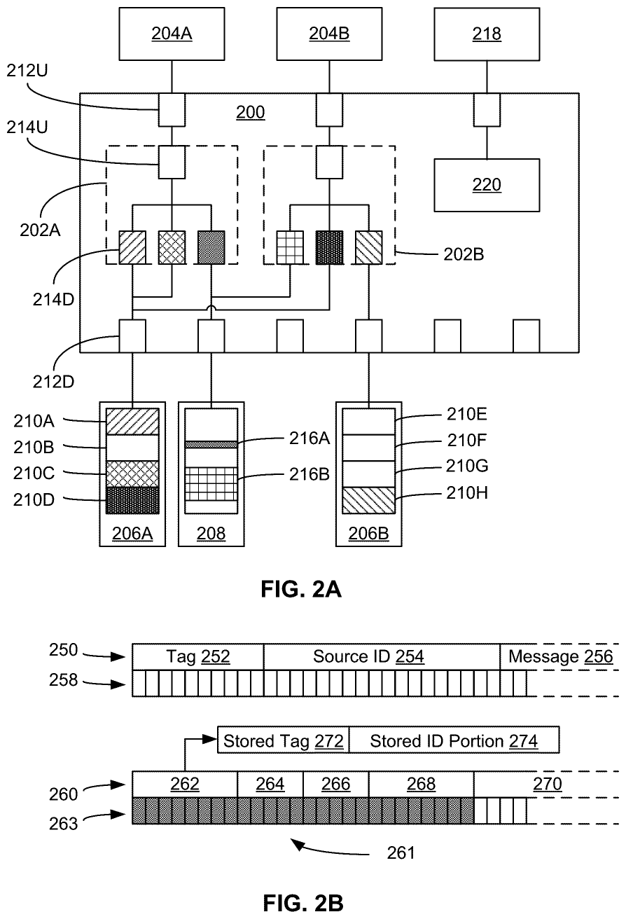

FIG. 2A is a block diagram illustrating an embodiment of switch 200. Switch 200 is analogous to switch 100. Switch 200 includes virtual switches 202A and 202B (collectively or generically virtual switch 202), fabric management module 220, and physical ports 212U (upstream physical port) and 212D (downstream physical port) (of which only one of each is labeled and which may be referred to collectively or generically as physical ports 212). Hosts 204A and 204B are coupled to physical ports 212U corresponding to virtual ports 214U (upstream virtual port) and 214D (downstream virtual port) (of which only one of each is labeled and which may be referred to collectively or generically as virtual ports 214) of virtual switches 202A and 202B. In the context of FIGS. 2A-2B, the terms “upstream” and “downstream” are for ease of explanation and may not indicate a particular configuration. Management host 218 is coupled to a physical port 212U corresponding to fabric management module 220. Physical devices 206A and 206B include multiple logical devices 210A, 210B, 210C, 210D, 210E, 210F, 210G, and 210H (collectively or generically, logical devices 210) and are coupled to physical ports 212D. Physical device 208 is a single logical device. Although two hosts 204A and 204B and three physical devices 206A, 206B, and 208 are shown, another number of hosts and/or physical devices may be present. Although eight logical devices 210 are included in physical devices 206A and 206B, another number of logical devices may be present. Further, another number of ports, virtual ports, and/or virtual switches may be present.

Virtual switches 202A and 202B connect multiple virtual ports 214U (i.e. virtual ports for hosts 204A and 204B) to the physical devices 206A, 206B, and 208 via the corresponding virtual ports 214D. Thus, multiple hosts 204A and 204B may be connected to the same physical device 206A and 208 (in the embodiment shown). Virtual ports (e.g. virtual ports 214U) may provide a translation of a local address for a virtual port destination to a global address for the physical destination (e.g. physical devices 206A, 206B, and 208). This address translation may associate each virtual port with a different portion of the downstream device memory or all virtual ports connected to that device may be associated with the same portion of device memory.

Logical devices 210A and 210C of physical device 206A are coupled to a physical port 212D corresponding to virtual ports 214D of virtual switch 202A. Logical device 210D of physical device 206A is coupled to the physical port 212D corresponding to a virtual port 214D of virtual switch 202B. Thus, hosts 204A and 204B share physical device 206A via virtual switches 202A and 202B. In some embodiments, hosts 204A and 204B may share the same logical device (e.g. logical device 210B) of physical device 206A. In order to route traffic between hosts 202A and 202B and different logical devices, the corresponding virtual ports 214U stores an identifier of the logical devices to which the hosts 202A and 202B are connected. Thus, each of the logical devices 210 may be associated with a unique global address.

Physical device 208 includes memory locations 216A and 216B. Memory location 216A is connected to a physical port 212D corresponding to a virtual port 214D of virtual switch 202A. Memory location 216B is connected to the physical port 212D corresponding to a virtual port 214D of virtual switch 202B. Each host 204A and 204B thus connects to physical device 208 through a different virtual port 214D. Each virtual port 214D may provide a translation of a local address for a virtual port destination to a global address for the physical destination (i.e. memory locations 216A and 216B). Thus, hosts 204A and 204B share physical device 208. Although shown as being connected to different memory locations 216A and 216B, in some embodiments, hosts 204A and 204B can share at least a portion of the same memory locations for physical device 208. Stated differently, some or all of memory locations 216A and 216B may be the same. However, memory locations 216A and 216B do not correspond to separate logical devices.

In some embodiments, management host 218 intercepts initial communications of hosts 204A and 204B (e.g., via fabric management module 220) and configures virtual switches 202A and 202B based on the initial communications. Hosts 204A and 204B may also be referred to as virtual hosts. The initial communications from hosts 204A and 204B may be used to identify physical devices 206A, 206B, and 208 to which hosts 202A and 202B are connected and to provide identifiers for hosts 202A and 202B. Configuring virtual switch 202A may include mapping a local identifier of host 204A (e.g., a source ID field from an initial communication of host 204A) to a location in virtual switch 202A, which may be indicated by virtual port 214U. In some embodiments, virtual switch 202A is configured to provide the TRS (e.g., as a portion of an outgoing communication). The TRS is unique to host 204A for switch 200. The TRS indicates the location in virtual switch 202A at which the local identifier of host 204A is stored. In some such embodiments, virtual switch 202A is configured to omit the TRS for a transaction between host 204A and management host 218. Virtual switch 204B may be configured in an analogous manner. Further, management host 218 may determine a global address space for hosts 204A and 204B, as well as for physical devices 206A, 206B, and 208.

Communication between the different devices 206A, 206B, and/or 208 or 204 hosts connected to ports 212 on switch 200 may take place via packets (self-contained blocks of information containing identifiers for the destination of the packet, and sometimes the source). A source host or device sends a request packet to a destination. The destination may send a response packet in return. A virtual switch 202 includes virtual ports 214 corresponding to the physical ports 212 and is configured to provide the TRS. In some embodiments, virtual switch 202 replaces a portion of a request packet with the TRS (discussed more fully with respect to FIG. 2B). The TRS corresponds to, and may replace, a local identifier for the source device. The TRS may also function as a unique, global identifier for the source device. In some embodiments, the TRS contains an identifier for the source physical port 212 and is unique to the source device (e.g. hosts 204) for the switch. Virtual switch 202 also replaces the TRS in a response packet with a portion of the original request packet (e.g. the local identifier of the source device). To do so, virtual switch 202A or 202B may use information in the TRS to obtain the portion of the original request packet.

FIG. 2B is a diagram illustrating an embodiment of packet 250 and an embodiment of modified packet 260 including corresponding TRS 261. TRS 261 provides a mechanism to route each response back to the correct source device when multiple source devices send requests to the same device (e.g. physical device 208). Packet 250 may be the local packet provided by a source for routing by the corresponding virtual switch to a destination. Packet 250 thus includes local address information for the source device and may be considered a request. TRS 261, which replaces a portion of request packet 250, contains a source identifier (e.g. a source port 214). When the responses are returned to the source port, the TRS is replaced with the original packet portion. In addition to the source identifier, the TRS contains information used to retrieve that original packet portion. Modified packet 260 includes global address information for the source of packet 250 and replaces packet 250 outside of the virtual switch. Thus, a virtual switch converts between packet 250 and modified packet 260.

TRS 261 is provided by a virtual switch (e.g. virtual switch 202A or 202B) on a switch (e.g. switch 200). Original packet 250 includes tag 252, source ID 254, and message 256. Message 256 may include the destination address for the destination to which original packet 250 is to be sent as well as the payload for original packet 250. Source ID 254 may be considered the local address of the host generating packet 250. The memory sizes of the grouping are indicated by bits 258. Although tag 252 is indicated to be ten bits and source ID 254 is indicated to be eighteen bits, the memory sizes and grouping of bits may differ.

TRS 261 is grouped into address 262, source port 264, logical device ID 266, and TRS active indicator 268 (corresponding to the highlighted portion of bits 263). The memory sizes of the grouping are indicated by bits 263. Although address 262 is indicated to be eight bits, source port 264 is indicated to be five bits, logical device ID 266 is indicated to be five bits, and TRS active indicator 268 is indicated to be eight bits, the memory sizes and grouping of bits may differ. Address 262 indicates the stored location of tag 252 and source ID 254. Source port 264 indicates the physical port for the device generating packet 250. Logical device ID 266 identifies the logical device (e.g. 210C), if any, for modified packet 260. TRS active indicator 268 indicates whether TRS 261 is used in routing modified packet 260. For example, TRS active indicator 268 indicates that TRS 261 is not used for communications with the management host. Based on the status of TRS indicator 268, a virtual switch may perform different functions. For example, if TRS active indicator 268 indicates that TRS 261 is not active, then the logical device ID 266 and address information 262 are not used in routing modified packet 260. If TRS active indicator 268 indicates that TRS 261 is used, then the virtual switch may store tag 252 and source ID 254 (i.e. provide stored tag 272 and stored ID portion 274) and access this information in routing packets.

Modified packet 260 includes a portion that has been overwritten by TRS 261 as well as an unmodified portion 270 of original packet 250. The portion of modified packet 260 overwritten by TRS 261 may be stored on switch 200. In the embodiment shown, the portion of modified packet 260 overwritten by TRS 261 includes stored tag 272 and stored ID portion 274. Stored tag 272 corresponds to tag 252, while stored ID 274 corresponds to source ID 254. Address 262 is used to retrieve the portion of modified packet 260 that has been overwritten (e.g. stored tag 272 and stored ID portion 274). Stated differently, address 262 identifies the location on switch 200 at which stored tag 272 and stored ID 274 are saved. Address 262 may thus be considered the global address for the source of packet 250, while source ID 254 may be the local address for the source of packet 250. In some embodiments, a response to modified packet 260 (i.e., from a destination device) contains TRS 261. The virtual switch may be configured to replace TRS 261 in the response with the portion stored in the virtual switch (e.g. stored tag 272 and stored ID portion 274). Original portion 270 of modified packet 260 may be the same as a corresponding portion of original packet 250 (e.g., two bits of source ID 254 and all of message 256).

Thus, virtual switches 202A and 202B may replace original packet 250 with modified packet 260 for communications from hosts 204A and 204B to physical devices 206A, 206B, and 208. Virtual switches 202A and 202B use the TRS contained in responses from, e.g., physical devices 206A, 206B, and 208 to retrieve the local identifying information 272 and 274 for the corresponding hosts 204A and 204B. Thus, TRS 261 may be considered global addressing information used in routing of communications through switch 200, while source ID 254 and, optionally, tag 252, may be considered local information used in routing communications with hosts 204 within virtual switches 202.

In one example, host 204A is to send original packet 250 to physical device 206A. Source ID 254 and/or tag 252 may be used as a local identifier of host 204A. Virtual switch 202A is configured to receive original packet 250 from host 204A and provide TRS 261. Address 262 is able to be used to retrieve stored tag 272 and stored ID portion 274 (e.g., to determine the local identifier of host 204A). Source port 264 and/or logical device ID 266 may be based on host 204A. Thus, TRS 261 is unique to host 204A for switch 200. Stated differently, TRS 261 may be considered global addressing information used in routing packets from host 204A through switch 200 (e.g. outside of virtual switch 202A). Virtual switch 202A overwrites a portion of original packet 250 with TRS 261, generating modified packet 260. Virtual switch 202A may send modified packet 260 to a downstream physical port 212D connected to its destination: physical device 206A (e.g., via a switch fabric, not labeled).

Physical device 206A may send a response to modified packet 260. The response may include TRS 261. The response may share the format of modified packet 260. TRS 261 may be used to route the response to the appropriate virtual switch 202A. Virtual switch 202A receives the response from physical device 206A (e.g., via a downstream physical port 212D). Further, virtual switch 202A may route the response to host 204A based at least in part on TRS 261. To do so, virtual switch 202A may be configured to replace TRS 261 in the response with stored tag 272 and stored ID portion 274 (e.g., via address 262). The response may then be routed within virtual switch 202A to upstream physical port 214U and host 204A. Thus, the response may share the format of the original packet 250.

TRS 261 allows the host to use its own source ID 254 when sending packet 250. The corresponding virtual switch replaces source ID 254 (among other information) in packet 250 with TRS 261, generating modified packet 260. The virtual switch routes modified packet 250 to the appropriate destination using destination information in message 256 (or 270). Responses to modified packet 260 may be routed from the destination through the switch to the virtual switch using global addressing information in TRS 261. The virtual switch obtains the local address (i.e., source ID 254 or 274) from address 262 in TRS 261. The virtual switch then routes the response to the source using the local address. Consequently, any duplication of local source information for different hosts does not impact routing of packets through the switch. TRS 261 allows the switch to route traffic through the switch even though the hosts may have conflicting (i.e., identical and/or not unique) local address information within the corresponding virtual switch.

In the above example, a communication occurred between host 204A and physical device 206A via virtual switch 202A. However, other switches, hosts, and/or physical devices as well as other number(s) and/or configurations of switch(es), host(s) and/or physical devices may be used. In some embodiments, a first downstream device (e.g., physical device 206A) can exchange peer-to-peer communications with a second downstream device (e.g., physical device 208). In some embodiments, a source device (e.g., host 204A) is another switch or a device coupled to another switch. In these situations, TRS 261 may similarly be used to facilitate routing of traffic between the source device and destination device.

In another example, logical device 210A of physical device 206A is to send original packet 250 to physical device 206B. Source ID 254 and/or tag 252 may be used as a local identifier of logical device 210A. Virtual switch 202A is configured to receive original packet 250 from logical device 210A and provide TRS 261. In some embodiments, address 262 is able to be used to retrieve stored tag 272 and stored ID portion 274 (e.g., to determine the local identifier of logical device 210A). In some embodiments, source port 264 and logical device ID 266 may be used to identify logical device 210A. Source port 264 and/or logical device ID 266 may be based on logical device 210A. For example, source port 264 may be an address of a first downstream physical port 212D coupled to physical device 206A, while logical device ID 266 may correspond to 210A of the multiple logical devices 210 within physical device 206A. Thus, TRS 261 is unique to logical device 210A for switch 200. Stated differently, TRS 261 may be considered global addressing information used in routing packets from logical device 210A through switch 200 (e.g. outside of virtual switch 202A). Virtual switch 202A overwrites a portion of original packet 250 with TRS 261, generating modified packet 260. Virtual switch 202A may send modified packet 260 to a second downstream physical port 212D connected to its destination: physical device 206B (e.g., via a switch fabric, not labeled).

In this example, physical device 206B may send a response to modified packet 260. The response may include TRS 261. The response may share the format of modified packet 260. TRS 261 may be used to route the response to the appropriate virtual switch 202A. Virtual switch 202A receives the response from physical device 206B (e.g., via the second downstream physical port 212D). Further, virtual switch 202A may route the response to logical device 210A based at least in part on TRS 261. To do so, virtual switch 202A may be configured to replace TRS 261 in the response with stored tag 272 and stored ID portion 274 (e.g., via address 262) and/or with source port 262 and logical device ID 266. The response may then be routed within virtual switch 202A to the first downstream physical port 212D and logical device 210A of physical device 206A. Thus, the response may share the format of the original packet 250. Thus, TRS 261 may be used to facilitate routing to hosts having local address information for a corresponding virtual switch that may conflict with another host's local address information on another virtual switch. TRS 261 may also allow for peer-to-peer communications between, for example, physical devices 206 and 208.

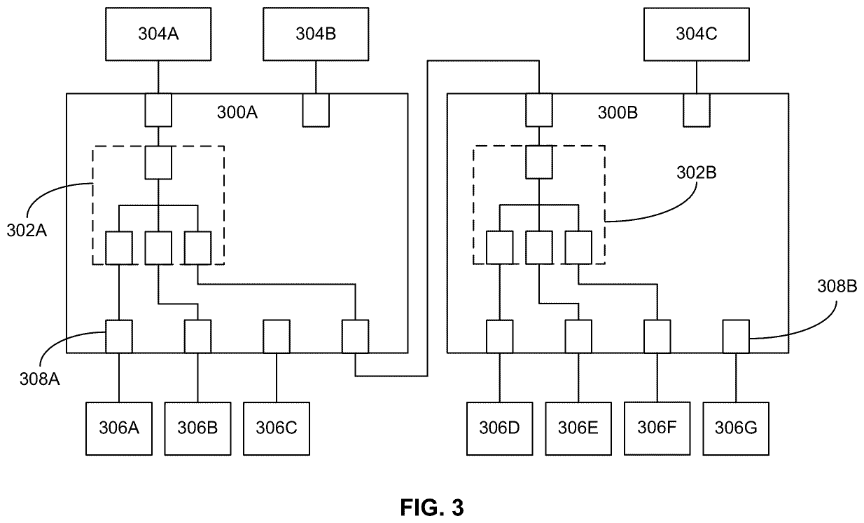

FIG. 3 is a block diagram illustrating an embodiment of switches 300A and 300B. Switches 300A and 300B are analogous to switch(es) 100 and/or 200. Switch 300A includes virtual switch 302A and physical ports 308A (of which only one is labeled). Switch 300B includes virtual switch 302B and physical ports 308B (of which only one is labeled). Hosts 304A and 304B are coupled to physical ports 308A of switch 300A. Host 304C is coupled to a physical port 308B of switch 300B. Physical devices 306A, 306B, and 306C are coupled to physical ports 308A of switch 300A. Physical devices 306D, 306E, 306F, and 306G are coupled to physical ports 308B of switch 300B. Although three hosts 304 and seven physical devices 306 are shown coupled to switches 300A and 300B, another number of hosts and physical devices may be present. Further, another number of ports, virtual ports, and/or virtual switches may be present. Although management hosts may be connected to switches 300A and 300B, for simplicity no management host is shown.

Virtual switch 302A is configured to provide a TRS unique to a source device for switch 300A and corresponding to a local identifier of the source device coupled with a corresponding physical port. Host 304A may be a source device for virtual switch 302A, with switch 300B, physical device 306A, and physical device 306B being downstream devices. Thus, the TRS of virtual switch 302A may correspond to a local identifier of host 304A and be unique to host 304A for switch 300A.

Virtual switch 302B is configured to provide a TRS unique to a source device for switch 300B and corresponding to a local identifier of the source device coupled with a corresponding physical port. Switch 300A may be a source device for virtual switch 302B, with physical device 306D, physical device 306E, and physical device 306F being downstream devices. Thus, the TRS of virtual switch 302B may correspond to a local identifier of switch 300A and be unique to switch 300A for switch 300B. In some embodiments, switch 300B may be a source device for switch 300A, with physical devices 306A, 306B, and 306C being downstream devices for switch 306B.

In some embodiments, virtual switch 302A provides a translation of a local address for a destination (e.g. a downstream device) to a global address for the destination. In some such embodiments, virtual switch 302A associates a portion of a downstream device with the global address unique to the portion of the downstream device for the switch. For example, host 304A may send a packet to physical device 306D. Virtual switch 302A may provide a translation of a local address for physical device 306D to a global address (unique to physical device 306D for switch 300A). Physical devices 306D, 306E, and 306F may be treated as portions of switch 300B and associated with unique global addresses for switch 300A. Virtual switch 302B may then receive the packet via a physical port 308B. Virtual switch 302B may consider the address for physical device 306D local for switch 300A and provide a translation of the address to a global address unique to physical device 306D for switch 300B.

Using the TRS, switches 300A and 300B may be able to be cascaded. Devices 304A, 306A, and 306B connected to one switch 300A may communicate with devices 306D, 306E, and/or 306F connected to another switch 300B. Thus, the number of devices that may rapidly and readily exchange information may be increased.

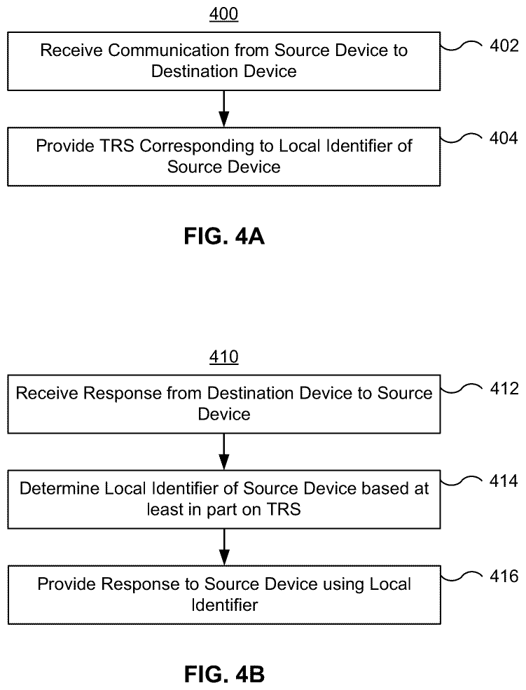

FIG. 4A is a flow diagram illustrating an embodiment of process 400 for communicating via a switch. For simplicity, only some steps are shown. Further, portions of method 400 may be performed in another order, including but not limited to in parallel. Method 400 is also described in the context of virtual switch 202A, and a particular number of source and destination devices. However, method 400 may be used for other switches, hosts, and/or physical devices as well as for other number(s) and/or configurations of switch(es), host(s) and/or physical device(s).

In 402, a communication (e.g., a packet) from a source device to a destination device is received. In 404, a TRS corresponding to a local identifier of the source device is provided. In some embodiments, the communication of 402 contains the local identifier of the source device. The local identifier of the source device may be determined in another manner, e.g., via an initial communication of the source device. In 404, providing the TRS may include overwriting a portion of the communication of 402 with the TRS. In some embodiments, the communication is sent to the destination device (e.g., in response to or after at least a portion of the communication is overwritten with the TRS).

In one example, host 204A sends original packet 250 to physical device 206A. Source ID 254 and/or tag 252 may be used as a local identifier of host 204A. Virtual switch 202A implements method 400, receiving original packet 250 in 402. Virtual switch 202A provides TRS 261 in 404. Virtual switch 202A may overwrite a portion of original packet 250 with TRS 261, generating modified packet 260. Virtual switch 202A sends modified packet 260 to a downstream physical port 212D connected to physical device 206A via a switch fabric.

In another example, logical device 210A of physical device 206A sends original packet 250 to physical device 208. In some embodiments, source ID 254 and/or tag 252 may be used as a local identifier of logical device 210A. In some embodiments, source port 264 and logical device ID 266 are used as an identifier for logical device 210A. Virtual switch 202A implements method 400, receiving original packet 250 from logical device 210A of physical device 206A in 402. Virtual switch 202A provides TRS 261 in 404. Virtual switch 202A may overwrite a portion of original packet 250 with TRS 261, generating modified packet 260. Virtual switch 202A sends modified packet 260 to a downstream physical port 212D connected to physical device 208 via a switch fabric.

FIG. 4B is a flow diagram illustrating an embodiment of process 410 for communicating via a switch. For simplicity, only some steps are shown. Further, portions of method 410 may be performed in another order, including but not limited to in parallel. Method 410 is also described in the context of virtual switch 202A, and a particular number of source and destination devices. However, method 410 may be used for other switches, hosts, and/or physical devices as well as for other number(s) and/or configurations of switch(es), host(s) and/or physical device(s).

In 412, a response to a communication (e.g., a packet) from a destination device to a source device is received. In 414, a local identifier of the source device is determined based at least in part on a TRS. A portion of the communication and/or the response may include the TRS. In 416, the response is provided to the source device using the local identifier. In some embodiments, the local identifier overwrites a portion of the response (e.g., a portion including the TRS).

In one example, physical 206A sends a response to a modified packet 260 from host 204A. Virtual switch 202A implements method 410, receiving the response to modified packet 260 in 412. Virtual switch 202A provides source ID 254 and/or tag 252 from TRS 261 in 414. To do so, virtual switch 202A may use address 262 to access stored tag 272 and stored ID 274. Virtual switch 202A locally routes the response to host 204A in 416. Thus, using a TRS, traffic can be routed between hosts and physical devices even in the case where hosts have conflicting local identifications.

In another example, physical device 208 sends a response to modified packet 260 from logical device 210A of physical device 206A. Virtual switch 202A uses method 410, receiving the response to modified packet 260 in 412. Virtual switch 202A provides source ID 254 and tag 252 and/or source port 264 and logical device ID 266 as a local identifier for logical device 210A in 414. Virtual switch 202A locally routes the response to logical device 210A. Thus, using a TRS, traffic can be routed between physical devices.

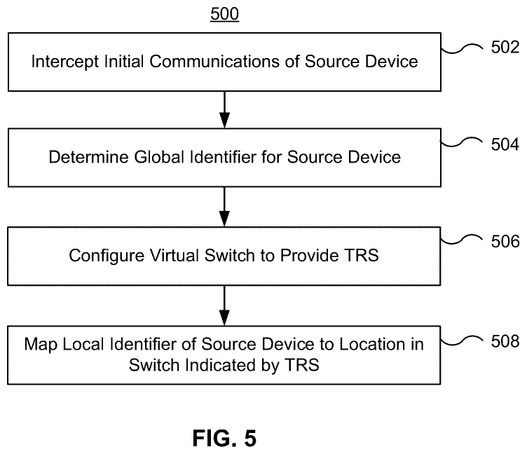

FIG. 5 is a flow diagram illustrating an embodiment of process 500 for configuring a virtual switch. For simplicity, only some steps are shown. Further, portions of method 500 may be performed in another order, including but not limited to in parallel. Method 500 is also described in the context of a management host, and a particular number of source and destination devices. However, method 500 may be used for other switches, hosts, and/or physical devices as well as for other number(s) and/or configurations of switch(es), host(s) and/or physical devices. Method 500 may be performed for each host coupled with a switch.

In 502, initial communications of a source device (i.e., a host) are intercepted (e.g., by a management host coupled with a switch). The initial communications may include configuration communications. The source device, or host, may be coupled with a physical port of the switch. The initial communications may enumerate devices to which the source device is connected (e.g., via a virtual switch) as well as identifying the source device. Thus, the initial communications may include the local identifiers of the source device and one or more devices coupled to the source device. In 504, 506, and 508, a virtual switch corresponding to the physical port is configured based on the initial communications. In 504, a global identifier may be determined for the source device (e.g., source port 264 and logical device ID 266 of FIG. 2B). In 504, therefore, the global address space for devices coupled to the switch may be updated (or provided) such that the source device is included. In some embodiments, the initial communications include a local identifier of the source device. The global identifier may be determined based on the local identifier of the source device. In 506, the virtual switch is configured to provide a TRS. The TRS is unique to the source device for the switch, is based on the global identifier (e.g. includes the physical port of the source device), and corresponds to the local identifier (e.g. the local identifier may be accessed using information in the TRS). Configuring the virtual switch to provide the TRS in 506 may include configuring the virtual switch to overwrite a portion of the packet in outgoing requests packets with the TRS and to replace the TRS with the local identifier for the source device for incoming responses. In 508, the local identifier of the source device is mapped to a location in the virtual switch indicated by the virtual port for the source device. In some embodiments, 508 may be considered part of configuring the virtual switch in 506. The location of the local identifier is indicated in the TRS. The TRS may include an address of the local identifier and the virtual switch may be configured to replace the TRS with the local identifier (e.g., in a response to a sent message including the TRS).

In one example, management host 218 implements method 500 via fabric management module 220. Management host 218 intercepts initial communications of host 204A in 502. The initial communications include a local identifier of host 204A. In 504, management host 218 determines a global identifier for host 204A based on the local identifier of host 204A. For example, management host 218 may determine physical port 212U for host 204A. Management host 218 also configures virtual switch 202A to provide TRS 261 in 506 (e.g., as a part of an outgoing communication) and to replace TRS 261 in response packets (e.g. to obtain stored tag 272 and source ID 274 using address 262 and to replace TRS 261 with stored tag 272 and source ID 274). Because virtual switch 202A is configured by management host to provide TRS 261, in some embodiments management host 218 may be considered to determine TRS 261 (i.e. may determine information that virtual switch 202A uses to fill the fields 262, 264, 266, and 268 contained in a TRS). Management host 218 then maps the local identifier of host 204A to a location in virtual switch 202A indicated virtual port 214U. This location is indicated in TRS 261 (e.g., via address 262). In some embodiments, virtual switch 202A is configured to omit TRS 261 for a transaction between host 204A and management host 218. Further, management host 218 may determine a global address space for hosts 204A and 204B, as well as for physical devices 206A, 206B, and 208.

Thus, using method 500, the local identity and the global identity of the source device may be determined. The source device may communicate within the virtual switch using its local identity. However, the global identity of the source device is unique and can be used to route traffic outside of the virtual switch. Therefore, multiple hosts (which may have local identities that conflict) can be connected with and have traffic routed through a switch.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A switch, comprising:
a plurality of physical ports:
a plurality of virtual switches including a plurality of virtual ports corresponding to the plurality of physical ports, a virtual switch of the plurality of virtual switches configured to provide a translated routing structure (TRS) corresponding to a local identifier of a source device coupled with a corresponding physical port, the TRS being unique to the source device for the switch; and
a switch fabric that interconnects the plurality of physical ports.

2. The switch of claim 1, wherein the switch is a Compute Express Link (CXL) switch.

3. The switch of claim 1, wherein a management host is coupled to the switch, the management host intercepting initial communications of the source device and configuring the virtual port based on the initial communications.

4. The switch of claim 3, wherein the management host configuring the virtual switch includes mapping the local identifier of the source device to a location in the virtual switch indicated by a corresponding virtual port.

5. The switch of claim 3, wherein the management host determines a global address space for devices connected to the switch.

6. The switch of claim 3, wherein the virtual switch omits the TRS for a transaction between the source device and the management host.

7. The switch of claim 1, wherein the virtual switch provides a translation of a local address for a destination to a global address for the destination.

8. The system of claim 7, wherein the virtual switch associates a portion of a downstream device with a global address unique to the portion of the downstream device for the switch.

9. The system of claim 8, wherein a physical port of the plurality of physical ports is connected to a device comprising multiple logical devices.

10. The system of claim 9, wherein the TRS further comprises:
an identifier of a logical device of the multiple logical devices.

11. The switch of claim 7, wherein the switch routes a response from the destination based at least in part on the TRS.

12. The switch of claim 1, wherein a source device comprises a second switch.

13. The switch of claim 1, wherein the TRS further comprises:
an indicator of whether the TRS is in use in a transaction.

14. The switch of claim 1, wherein a portion of a packet is overwritten by the TRS.

15. The switch of claim 14, wherein the portion of the packet overwritten by the TRS is stored on the switch.

16. The switch of claim 15, wherein the TRS further comprises an address of the portion of the packet overwritten by the TRS.

17. The switch of claim 16, wherein the virtual switch receives a response to the packet, the response including the TRS, the virtual switch being configured to replace the TRS in the response with the portion of the packet stored on the switch.

18. The switch of claim 1, wherein the plurality of physical ports includes a first downstream port and a second downstream port, the first downstream port being connected to a first device and the second downstream port being connected to a second device, wherein the first device can exchange peer-to-peer communications with the second device via the switch fabric.

19. A method, comprising:
receiving, at a virtual switch, a communication from a source device to a destination device, the source device being coupled to a physical port corresponding to the virtual switch, the physical port being one of a plurality of physical ports; and
providing, for the communication, a translated routing structure (TRS) corresponding to a local identifier of the source device, the TRS being unique to the source device, the TRS being usable in routing a response from the destination device to the source device.

20. A method, comprising:
intercepting, by a management host coupled with a switch, initial communications of a host device coupled with a physical port of a plurality of physical ports of the switch;
configuring a virtual switch corresponding to the physical port based on the initial communications, the configuring including:
determining a global identifier for the host device; and
configuring the virtual switch to provide a translated routing structure (TRS) corresponding to a local identifier of the host device, the TRS being unique to the host device for the switch and based on the global identifier.
